(19) United States
(12) Patent Application Publication
(10) Pub. No.: US 2005/0104253 A1
(43) Pub. Date: May 19, 2005

(54) Production method and production apparatus of pattern-indented sheet

(76) Inventors: Ryuichi Katsumoto, Fujinomiya-shi (JP); Tadahiro Kegasawa, Fujinomiya-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/984,975

(22) Filed: Nov. 10, 2004

(30) Foreign Application Priority Data
Nov. 11, 2003 (JP) 2003-381427
Nov. 11, 2003 (JP) 2003-381428

(51) Int. Cl. H05B 6/02; B29C 59/04

(52) U.S. Cl. 264/284; 264/479; 264/486; 425/363

(57) ABSTRACT

A production method of a pattern-indented sheet comprising the steps of pressing a continuously running sheet-shaped medium with a indented roller and a nip roller which are rotating so as to transfer and form indentation of the indented roller surface onto a surface of the sheet-shaped medium and locally heating an upstream portion of a pressing spot of the indented roller.

### BACKGROUND OF THE INVENTION

1. Field of the Invention

The present invention relates to a production method and a production apparatus of a pattern-indented sheet, and particularly to a production method and a production apparatus of a pattern-indented sheet which is preferable for producing a sheet-shaped product such as an embossed sheet having an anti-reflection effect and the like, on which surface a microscopic indented pattern is formed, at a high production speed.

2. Description of the Related Art

Embossed sheets having an anti-reflection effect are adopted for use in electronic displays such as liquid crystal in recent years. Embossed sheets which include planar lenses such as a lenticular lens and a fly eye lens, a light diffusion sheet, a brightness enhancement sheet, an optical waveguide sheet, and the like, are used. As such embossed sheets, the one on which surface a regular microscopic indented pattern is formed is conventionally known.

As a method for forming such a regular microscopic indented pattern, various kinds of methods are conventionally known, and for example, the method of nipping a sheet-shaped medium with a heated embossing roller and a nip roller, and it is proposed that a microscopic indented pattern formed on the embossing roller is transferred onto the surface of the sheet-shaped medium (see Japanese Patent Application Publication No. 11-513333).

However, the prior art as described above (Japanese Patent Application Publication No. 11-513333) has the problem that the production speed is low. Namely, when the microscopic indented pattern which is formed on the embossing roller is transferred onto the surface of the sheet-shaped medium, it is necessary to increase the heating temperature of the embossing roller, or to increase the time during which the sheet-shaped medium is nipped with the embossing roller and the nip roller, in order to obtain favorable transfer precision of the microscopic indented pattern.

When the heating temperature of the embossing roller is made higher, however, it tends to be difficult to peel the sheet-shaped medium from the embossing roller. On the other hand, it is unfavorable for productivity to suppress the heating temperature of the embossing roller within the necessary range, and increase the time during which the sheet-shaped medium is nipped. When transfer is performed with the heating temperature of the embossing roller reduced, residual stress occurs in the sheet-shaped medium even if the transfer precision is favorable immediately after the transfer, thereby causing the problem that the transfer precision is reduced by the heat treatment and the like which will be performed hereinafter.

In order to cope with such a problem, there is a method of preliminarily heating the sheet-shaped medium immediately before the sheet-shaped medium is supplied to the embossing roller, but if the temperature of the preliminary heating is too high, the sheet-shaped medium is deformed (hangs down), before the indented pattern of the embossing roller is transferred onto the surface of the sheet-shaped medium, and the transfer cannot be performed.

### SUMMARY OF THE INVENTION

The present invention is made in view of the above circumstances, and has its object to provide a production method and a production apparatus of a pattern-indented sheet for forming a microscopic indented pattern on a sheet-shaped surface, which is a production method and a production apparatus of a pattern-indented sheet in high productivity, and preferable for producing an embossed sheet with favorable transfer precision.

In order to attain the above-described object, the present invention provides a production method of a pattern-indented sheet comprising the steps of pressing a continuously running sheet-shaped medium with a indented roller and a nip roller which are rotating so as to transfer and form indentation of the indented roller surface onto a surface of the sheet-shaped medium and locally heating an upstream portion of a pressing spot of the indented roller.

For this purpose, the present invention provides a production apparatus of a pattern-indented sheet comprising a sheet-shaped medium supplying device which feeds out a sheet-shaped medium a forming device which presses the sheet-shaped medium with an indented roller and a nip roller which are rotating so as to work the continuously running sheet-shaped medium by roller forming and a local heating device which locally heats an upstream portion of a pressing spot of the indented roller.

According to the present invention, the upstream portion of the pressing spot of the indented roller is locally heated when the continuously running sheet-shaped medium is worked by roller forming while the sheet-shaped medium is pressed with the indented roller and the nip roller which are rotating. Namely, the entire indented roller is not heated to a desired temperature necessary for the transfer with high precision, but only the spot immediately before the pressing of the indented roller is heated to the desired temperature necessary for the transfer with high precision. As a result, the pattern-indented sheet with favorable transfer precision can be produced, and cooling of the indented roller is advanced by the time the sheet-shaped medium is peeled from the indented roller, thus making it easy to peel the sheet-shaped medium from the indented roller. Accordingly, the production method and the production apparatus of a pattern-indented sheet with high productivity can be provided.

It is noted that in this specification, “the indented roller” not only includes the embossing roller with an indented pattern (embossed shape) formed on a surface of the cylindrical roller, but also includes those having indented patterns (embossed shapes) formed on the surfaces of the belt-shaped media such as an endless belt. This is because even such a belt-shaped medium operates similarly to the cylindrical rollers, and the same effect can be obtained.

As the local heating device, various kinds of heating devices such as an infrared heater, a halogen heater, a hot air generating device and a burner can be adopted.

The present invention provides a production method of a pattern-indented sheet comprising the steps of continuously running a layered medium of a sheet-shaped medium and a band-shaped flexible support medium placed on an undersurface of the sheet-shaped medium pressing the layered medium with the indented roller and a nip roller which are rotating so as to transfer and form indentation of an indented roller surface onto a surface of the sheet-shaped medium and locally heating an upstream portion of a pressing spot of the indented roller.

For this purpose, the present invention provides a production apparatus of a pattern-indented sheet comprising a sheet-shaped medium supplying device which feeds out a sheet-shaped medium, a support medium transporting device which circularly transports a band-shaped flexible support medium which is an endless belt a forming device which continuously runs a layered medium of the sheet-shaped medium and the support medium placed on an undersurface of the sheet-shaped medium, and presses the layered medium with an indented roller and a nip roller which are rotating so as to work the sheet-shaped medium by roller forming a peeling device which peels the layered medium from the indented roller and a local heating device which locally heats an upstream portion of a pressing spot of the indented roller.

According to the present invention, the upstream portion of the pressing spot of the indented roller is locally heated when the continuously running sheet-shape medium is worked by roller forming while the sheet-shaped medium is being pressed with the indented roller and the nip roller which are rotating. Namely, the entire indented roller is not heated to a desired temperature necessary for the transfer with high precision, but only the spot immediately before the pressing of the indented roller is heated to the desired temperature necessary for the transfer with high precision. As a result, the pattern-indented sheet with favorable transfer precision can be produced, and cooling of the indented roller is advanced by the time the sheet-shaped medium is peeled from the indented roller, thus making it easy to peel the sheet-shaped medium from the indented roller. Accordingly, the production method and the production apparatus of a pattern-indented sheet with high productivity can be provided.

According to the present invention, when the sheet-shaped medium is supplied to the indented roller, the layered medium of the sheet-shaped medium and the band-shaped flexible support medium placed on the undersurface of the sheet-shaped medium is made to run continuously to perform roller forming work. The endless belt which is circularly transported is adopted as the support medium, so that the apparatus construction is facilitated. When the back surface of the sheet-shaped medium is worked to be smooth, the surface of the support medium needs to be in the mirror surface state, but in this case, the length of the support medium can be made the minimum length by using the endless belt as the support medium. On the other hand, in the construction in which the support medium is fed out by the device such as a support medium supplying device and the support medium is housed by the device such as a support medium housing device, the required length of the support medium with the surface formed in the mirror surface state is very long, and thus the cost is increased significantly.

In the present invention, it is preferable the local heating device is a dielectric heating device provided in the vicinity of the indented roller. The above described various kinds of heating devices can be adopted as the local heating device, but the dielectric heating device can perform local heating of the indented roller efficiently, and the advantageous effect of the present invention can be favorably obtained.

Here, “Dielectric Heating” means that the matter is heated by its electric loss (dielectric loss) when the matter having the property of an electrical insulator is placed in the AC electric field.

In the present invention, it is preferable that a height of the indentation of the sheet-shaped medium surface by the transferring and forming is 90% or more of a height of the indentation of the indented roller surface. Such a transfer rate can be achieved by optimizing the setting of the heating temperature corresponding to the physical property of the sheet-shape medium, the treatment after the transfer to peeling (temperature control, control of the pressuring state, and the like), and the like.

In order to attain the aforesaid object, the present invention provides a production method of a pattern-indented sheet comprising the steps of continuously running a layered medium of a sheet-shaped medium and a band-shaped flexible support medium placed on an undersurface of the sheet-shaped medium pressing the layered medium with the indented roller and a nip roller which are rotating so as to transfer and form indentation of an indented roller surface onto a surface of the sheet-shaped medium and heating the sheet-shaped medium in an upstream portion of a pressing spot of the indented roller.

For this purpose, the present invention provides a production apparatus of a pattern-indented sheet, comprising a sheet-shaped medium supplying device which feeds out a sheet-shaped medium; a support medium supplying device which feeds out a band-shaped flexible support medium a forming device which continuously runs a layered medium of the sheet-shaped medium and the support medium placed on an undersurface of the sheet-shaped medium, and presses the layered medium with an indented roller and a nip roller which are rotating so as to work the sheet-shaped medium by roller forming and a heating device which heats the sheet-shaped medium in an upstream portion of a pressing spot of the forming device.

According to the present invention, when the sheet-shaped medium is supplied to the indented roller, the layered medium of the sheet-shaped medium and the band-shaped flexible support medium placed on the undersurface of the sheet-shaped medium is made to run continuously, and roller forming work is performed while the layered body is being pressed with the indented roller and the nip roller which are rotating. The sheet-shaped medium is heated (preliminary heating) in the upstream portion of the pressing spot of the forming device. Since the sheet-shaped medium is preliminarily heated in this manner, the pattern-indented sheet with favorable transfer precision can be produced. Since the sheet-shaped medium is made to run continuously as the layered medium with the band-shaped flexible support medium being placed on the undersurface of the sheet-shaped medium, the problem that the sheet-shaped medium is deformed (hangs down) and transfer cannot be performed can be eliminated, even if the temperature of the preliminary heating is high. Accordingly, the production method and the production apparatus of the pattern-indented sheet with high productivity can be provided.

However, it is preferable to use the medium with higher heat-resistant than the sheet-shaped medium as the band-shaped flexible support medium. Otherwise, the support medium is similarly deformed by the preliminary heating, and cannot perform the function as the support medium.

As the heating device for preliminary heating, various kinds of heating devices such as an infrared heater, a halogen heater and a hot air generating device can be adopted.

In the present invention, it is preferable to include a peeling device which peels the layered medium from the indented roller; a support medium housing device which houses the support medium after the peeling; and a sheet-shaped medium housing device which houses the sheet-shaped medium after the peeling. By including various kinds of devices like them, the sheet-shaped medium and the like can be efficiently housed.

In the present invention, it is preferable to perform the heating by a condensing heater. The above described various kinds of heating devices can be adopted as the preliminary heating device, but if the preliminary heating device is the condensing heater, the sheet-shaped medium can be efficiently heated.

In the present invention, it is preferable that a height of the indentation of the sheet-shaped medium surface by the transfer forming is 90% or more of a height of the indentation of the indented roller surface. Such a transfer rate can be achieved by optimizing the setting of the heating temperature corresponding to the physical property of the sheet-shape medium, the treatment after the transfer to the peeling (temperature control, control of the pressuring state, and the like), and the like.

The present invention provides a production apparatus of a pattern-indented sheet, comprising a sheet-shaped medium supplying device which feeds out a sheet-shaped medium a support medium transporting device which circularly transporting a band-shaped flexible support medium which is an endless belt a forming device which continuously runs a layered medium of the sheet-shaped medium and the support medium placed on an undersurface of the sheet-shaped medium, and presses the layered medium with an indented roller and a nip roller which are rotating so as to work the sheet-shaped medium by roller forming a peeling device which peels the layered medium from the indented roller and a heating device which heats the sheet-shaped medium in an upstream portion of a pressing spot of the forming device.

According to the present invention, the endless belt which is circularly transported is adopted as the support medium, and the apparatus construction is facilitated. When the back surface of the sheet-shaped medium is worked to be smooth, the surface of the support medium needs to be in the mirror surface state, but in this case, the length of the support medium can be made the minimum length by using the endless belt as the support medium. On the other hand, in the construction in which the support medium is fed out by the support medium supplying device and the support medium is housed into the support medium housing device, the required length of the support medium of which surface is in the mirror surface state is very long, and thus the cost can be increased significantly.

As explained thus far, according to the present invention, in the production of the pattern-indented sheet by transferring and forming indentation of the indented roller surface onto the surface of the sheet-shaped medium, the upstream portion of the pressing spot of the indented roller is locally heated when the continuously running sheet-shaped medium is worked by roller forming while the sheet-shaped medium is being pressed with the indented roller and the nip roller which are rotating. Namely, the entire indented roller is not heated to a desired temperature necessary for the transfer with high precision, but only the spot immediately before the pressing of the indented roller is heated to the desired necessary temperature for the transfer with high precision. As a result, the pattern-indented sheet with favorable transfer precision can be produced, and cooling of the indented roller advances by the time the sheet-shaped medium is peeled from the indented roller, thus making it easy to peel the sheet-shaped medium from the indented roller. Accordingly, the production method and the production apparatus of a pattern-indented sheet with high productivity can be provided.

According to the present invention, when the sheet-shaped medium is supplied to the indented roller, the layered medium of the sheet-shaped medium and the band-shaped flexible support medium placed on the undersurface of the sheet-shaped medium is made to run continuously, and the roller forming work is performed while the layered medium is being pressed with the indented roller and the nip. roller which are rotating. The sheet-shaped medium is heated (preliminary heating) in the upstream portion of the pressing spot of the forming device. The sheet-shaped medium is preliminarily heated as above, the pattern-indented sheet with favorable transfer precision can be produced. Since the sheet-shaped medium is made to run continuously as the layered medium with the band-shaped flexible support medium placed on the undersurface of the sheet-shaped medium, the problem that the sheet-shaped medium is deformed (hangs down) and the transfer cannot be performed can be eliminated even if the temperature of the preliminary heating is high. Accordingly, the production method and the production apparatus of the pattern-indented sheet with high productivity can be provided.

### BRIEF DESCRIPTION OF THE DRAWINGS

FIG. 1 is an explanatory view showing a construction of a production apparatus of an embossed sheet which is applied to the present invention;

FIG. 2 is a conceptual diagram explaining the principle of dielectric heating;

FIG. 3 is a graph showing a stress relaxation curve of the medium of a sheet-shaped medium;

FIG. 4 is an explanatory view showing another construction of the production apparatus of an embossed sheet which is applied to the present invention;

FIG. 5 is an explanatory view of still another construction of the production apparatus of an embossed sheet which is applied to the present invention;

FIG. 6 is an explanatory view showing yet another construction of the production apparatus of an embossed sheet which is applied to the present invention; and

FIG. 7 is an explanatory view showing a construction of a production apparatus of an embossed sheet which is applied to a comparative example.

### DETAILED DESCRIPTION OF THE PREFERRED EMBODIMENTS

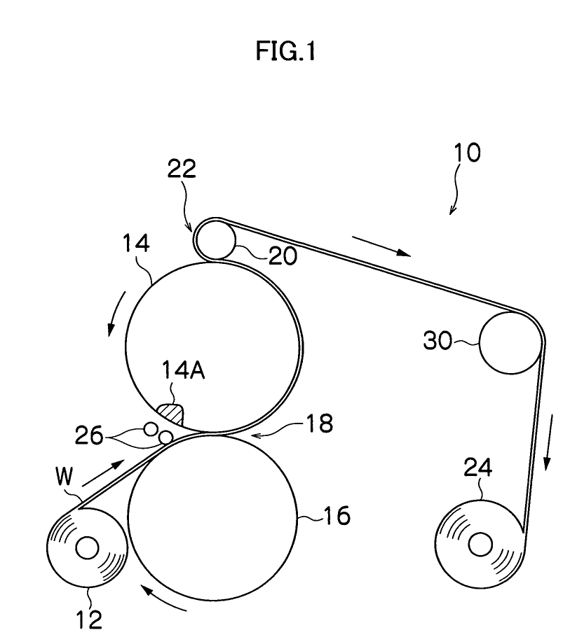

An embodiment of the present invention will be explained hereinafter based on the attached drawings. FIG. 1 is an explanatory view showing a construction of a production apparatus 10 of an embossed sheet, which is applied to the present invention. The production apparatus 10 of the embossed sheet is constructed by a sheet supplying device 12, a forming device 18 constituted of an embossing roller 14 being an indented roller and a nip roller 16, a peeling device 22 constituted of the embossing roller 14 and a peeling roller 20, a sheet housing device 24, and a local heating device 26 constituted of a dielectric heating coil or the like.

The sheet supplying device 12 feeds out a sheet W which is a sheet-shaped medium, and is constructed by a feeding-out roll around which the sheet W is wound, or the like.

The forming device 18 is a device which works the continuously running sheet W by roller forming while pressing the sheet W with the rotating embossing roller 14 and the nip roller 16, and the forming device 18 also has a pressurizing device (not shown) which applies the pressing force between the embossing roller 14 and the nip roller 16. The forming device 18 also has a driving device not shown which rotationally drives the embossing roller 14 and the nip roller 16 in the arrow direction shown in the drawing. The roller forming work is performed with the embossing roller 14 at the six o'clock position and the nip roller 16 at the twelve o'clock position.

The peeling device 22 is the device which peels the sheet W, which is wound on the circumferential surface of the embossing roller 14, from the embossing roller 14 and winds the sheet W on the peeling roller 20, while nipping the sheet W with the embossing roller 14 and the peeling roller 20. Peeling-off of the sheet W from the embossing roller 14 is performed by the embossing roller 14 at the twelve o'clock position, and by the peeling roller 20 at the six o'clock position.

The sheet housing device 24 houses the sheet W after peeled off, and is constructed by the winding roll which winds up the sheet W, or the like.

The local heating device 26 locally heats an upstream portion (approximately seven o'clock position) of the pressing spot (six o'clock position) of the embossing roller 14, and is constituted of a dielectric heating coil provided close to a spot to be heated 14A at approximately seven o'clock position of the embossing roller 14. The spot to be heated 14A is heated by the dielectric heating by the local heating device 26.

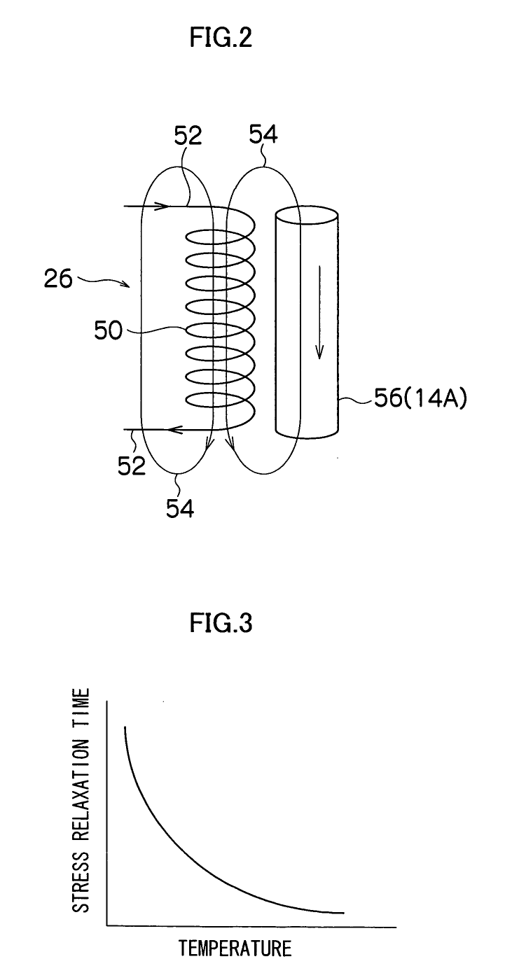

FIG. 2 is a conceptual diagram explaining the principle of the dielectric heating. When an electric current is passed to an dielectric heating coil 50 shown in the drawing in the direction of the arrow 52, magnetic flux occurs in the direction of the arrow 54, and a body to be heated 56 is heated by the magnetic flux.

A guide roller 30 which forms a conveying passage for the sheet W is provided between the peeling device 22 and the sheet housing device 24. In addition, a tension roller or the like may be provided to absorb looseness of the sheet W during conveyance as necessary.

As the sheet W which is applied to the present invention, thermoplastic resin is adopted because the transfer forming by heating is performed. As the thermoplastic resin, various kinds of known plastics, for example, polyethylene, polypropylene, polystyrene and the like are cited as hydrocarbon plastics, polyvinyl chloride, polyvinyl acetate, polymethyl methacrylate, ABS resin and the like are cited as polar vinyl plastics, polyacetal, polyamide, polycarbonate and the like are cited as the plastics of the floccular structure, cellulose acetate, celluloid cellophane and the like are cited as cellulosic plastics.

As the sheet W, not only the sheet of a single-layer structure, but also the sheet of the structure with two or more layers can be adopted. For example, the sheet of a two-layer structure, in which a medium with less deformation (for example, PET) in the forming device 18 is used as the base medium, and polymethyl methacrylate or the like with favorable transfer formability by heating is formed on the surface of this base medium, can be adopted. In addition, the sheet of the structure with three or more layers can be adopted.

However, in the present invention, in the case of the two-layer structure as described above, the glass transition temperature Tg of the thermoplastic resin is required to be lower than the glass transition temperature Tg of the base medium. Otherwise, the base medium is deformed when the thermoplastic resin is heated, and a favorable product cannot be obtained.

0.1 to 3 m is generally adopted as the width of the sheet W, 1000 to 100000 m is generally adopted as the length of the sheet W, and 0.5 to 1000 mm is generally adopted as the thickness of the sheet W. However, the other sizes than the above are not prevented from being adopted.

When the structure with two or more layers is adopted as the sheet W, corona discharge, plasma treatment, adhesion facilitating treatment, heat treatment, dust removing treatment and the like may be previously performed for the base medium. The surface roughness Ra of the base medium is preferably 3 to 10 nm at the cut off value of 0.25 mm. The base medium may use the medium that is previously provided with a foundation layer such as a bonding layer and is dried and hardened, and the medium that is previously formed another functional layer on back surface, or the like.

The embossing roller 14 is required to have the precision of the indented pattern, the mechanical strength, the heat resistance, circularity and the like with which the indentation of the roller surface can be formed by transfer. As the embossing roller 14 like this, a metal roller is preferable.

A regular microscopic indented pattern is formed on the outer circumferential surface of the embossing roller 14. Such a regular microscopic indented pattern is required to be the shape which is made by inversing the microscopic indented pattern on the surface of the pattern-indented sheet (embossed sheet) as a product.

The indented pattern on the outer circumferential surface of the embossing roller 14 may be the pattern which is not regular as long as a desired performance can be obtained.

The pattern-indented sheet (embossed sheet) as a product is intended for, for example, a lenticular lens on which the microscopic indented pattern is arranged two-dimensionally, for example, fly eye lens in which the microscopic indented pattern is arranged three-dimensionally, a flat lens, or the like, in which microscopic cones such as circular cones and pyramids are paved in the X and Y directions, and the regular microscopic indented pattern on the outer circumferential surface of the embossing roller 14 is conformed to the above products.

As the method for forming the regular microscopic indented pattern on the outer circumferential surface of the embossing roller 14, it can be adopted to form the indentation directly on the surface of the embossing roller 14 by photo etching, electron-beam rendering, laser work or the like can be adopted, or to form the indentation on the surface of a thin metal planter medium by photo etching, electron-beam rendering, laser work, a stereo lithography method, and fixing the planar medium by winding the planar medium around the roller to make the embossing roller 14. Other than the above methods, it also can be adopted to form the indentation on the surface of a medium which is more easily worked than metal by photo etching, electron-beam rendering, laser work, the stereo lithography method or the like, to form the mold of the inversed shape of this by electroforming or the like to make a thin metal planar medium, and to fix the planar medium by winding the planar medium around the circumference of the roller to make the embossing roller 14. Especially when the inversed mold is formed by electroforming or the like, there is provided the advantage that a plurality of planar media in the same shape can be obtained from one master (mother).

It is preferable to incorporate such a heating device as can keep the temperature of the entire embossing roller 14 at a predetermined temperature in the inside the embossing roller 14. In the case of the embossing roller 14 which does not have such a heating device, it is necessary to heat the spot to be heated 14A to the transfer forming temperature from the normal temperature (room temperature), and it is necessary to make the rating of the local heating device 26 larger, thus making the constraints in the apparatus larger. Peeling is possible even if the temperature of the embossing roller 14 in the peeling device 22 is not lowered to the normal temperature (room temperature).

From the above description, keeping the temperature of the entire embossing roller 14 at a predetermined temperature makes the efficient apparatus construction. For example, if the temperature of the entire embossing roller 14 is kept at a little lower temperature than the lower limit temperature of the condition under which peeling of the sheet W is possible, it is easy to heat the spot to be heated 14A to the transfer forming temperature, and the constraint in the apparatus is small.

As such a heating device, the construction can be adopted wherein a hollow portion is provided inside the embossing roller 14, and a heat medium is passed into this hollow portion. For example, the construction can be adopted wherein rotary joints are provided at both ends of the axis of the embossing roller 14, then the heat medium is supplied into the hollow portion from one of the rotary joints and the heat medium from the hollow portion is discharged from the other rotary joint. The construction may be adopted wherein a sheath heater is buried inside the embossing roller 14, and electric power is supplied to the sheath heater via a slip ring or the like.

Other than the above constructions, it can be adopted of the construction in which a hollow portion is provided inside the embossing roller 14 and cooling water or the like is passed into the hollow portion in order to positively lower the temperature of the embossing roller 14 in the peeling device 22, and the like.

In the spot to be heated 14A of the embossing roller 14 as shown in FIG. 1, it is preferable to use a metal medium with a high dielectric constant and a high resistance value as the medium of this spot in order to enhance efficiency during dielectric heating.

Further, the construction in which a heat insulating layer is provided in an inside (at a side of the center in a radius direction) of the spot to be heated 14A of the embossing roller 14 can be adopted in order that the effect of heating in the spot to be heated 14A of the embossing roller 14 is not exerted on the other part of the embossing roller 14.

It is preferable to apply mold releasing treatment to the surface of the embossing roller 14. The shape of the microscopic indented pattern can be favorably kept by applying the mold releasing treatment onto the surface of the embossing roller 14. As the mold releasing treatment, various kinds of known methods, for example, coating treatment by fluororesin can be adopted.

The local heating device 26 constituted of the dielectric heating coil passes a high-frequency current to the coil 50 for dielectric heating, forms the electromagnetic field 54, and passes a current to the surface portion of the embossing roller 14 (the spot to be heated 14A) as explained based on FIG. 2, and thereby performs the function of locally raising the temperature of the surface portion of the embossing roller 14 up to a predetermined temperature. As for voltage of the high-frequency current which is passed to the coil for dielectric heating, the frequency and the like, proper values can be adopted in accordance with the size of the embossing roller 14, the producing speed (circumferential speed of the embossing roller 14), the medium of the sheet W, the indented pattern on the embossing sheet surface and the like.

The nip roller 16 works the sheet W by roller forming while pressing the sheet W by being paired with the embossing roller 14, and is required to have predetermined mechanical strength, heat resistance, circularity and the like. If the modulus of longitudinal elasticity (Young's modulus) of the surface in the nip roller 16 is too small, the work by roller forming becomes insufficient, and when it is too large, it sensitively responds to rolling up of foreign matters such as dust and easily causes a fault. Therefore, it is preferable to set the modulus of longitudinal elasticity of the surface of the nip roller 16 at a proper value.

A mode in which a heating device is provided in an inside of the nip roller 16 can be adopted in order to assist heating in the spot to be heated 14A of the embossing roller 14 on the occasion of roller forming work.

The peeling roller 20 is paired with the embossing roller 14 and peels the sheet W from the embossing roller 14, and is required to have predetermined mechanical strength, heat resistance, circularity and the like. In the peeling device 22, the sheet W is peeled from the embossing roller 14 and is wound on the peeling roller 20 while the sheet, which is W wound on the peripheral surface of the embossing roller 14, is being nipped with the rotating embossing roller 14 and peeling roller 20. To ensure this operation, it is preferable that the peeling roller 20 is provided with the driving device.

To ensure peeling by cooling the sheet W during peeling, the construction can be adopted wherein the peeling roller 20 is provided with a cooling device.

Though not shown, the construction in which a plurality of backup rollers are provided to oppose each other in an area between the pressing spot (six o'clock position) of the embossing roller 14 up to the peeling spot (twelve o'clock position), and heat treatment is performed while the sheet W is pressed with a plurality of backup rollers and the embossing roller 14. In this case, in the first half part, the heating device is provided at the backup roller to keep the sheet W at a temperature close to the temperature at the time of transfer to enhance transfer precision, and in the latter half part, the cooling device is provided at the backup roller to keep the sheet W at a temperature close to the temperature at the time of peeling off the sheet W to enhance peeling performance.

Next, an operation of the production device 10 of the embossed sheet will be explained.

The sheet W is fed out of the sheet supplying device 12 at a constant speed. The sheet W is fed into the forming device 18 constituted of the embossing roller 14 and the nip roller 16. The upstream portion (approximately seven o'clock position) of the pressing spot (six o'clock position) of the embossing roller 14 is heated locally by the local heating device 26 constituted of the dielectric heating coils provided close to the upstream portion. Thus, in the forming device 18, roller-forming work is performed for the continuously running sheet W while the continuously running sheet W is pressed with the rotating embossing roller 14 and the nip roller 16.

On this occasion, the temperature of the entire embossing roller 14 is kept at a little lower temperature than the lower limit temperature of the condition under which it is possible to peel off the sheet W. Then, the spot to be heated 14A is locally heated to the transfer forming temperature. By controlling the temperature like this, the spot to be heated 14A can be quickly kept at the transfer forming temperature even if the electric power which is consumed in the local heating device 26 is very low.

As described above, when the heating temperature of the embossing roller 14 is too high, it tends to be difficult to peel the sheet W from the embossing roller 14. On the other hand, when the transfer is performed by setting the heating temperature of the embossing roller 14 low, the residual stress occurs in the sheet-shaped medium even if the transfer precision is favorable immediately after the transfer, and there exists the problem of reducing the transfer precision by the heat treatment and the like which are performed thereafter.

Accordingly, it is necessary to select suitable transfer forming temperature corresponding to the medium of the sheet W, feeding speed and the like. On this occasion, it is preferable to obtain the stress relaxation curve in which the measurement values evaluating the medium of the sheet W are plotted with the temperature of the medium of the sheet W plotted in the horizontal axis and the stress relaxation time of the sheet medium is plotted in the vertical axis, and select a proper transcription forming temperature, as shown in FIG. 3.

The sheet W passing through the forming device 18 is conveyed to the counterclockwise direction while being wound on the embossing roller 14 and fed to the peeling device 22. On this occasion, the surface temperature of the embossing roller 14 reduces to be lower than the transfer forming temperature, and with this, the temperature of the sheet W reduces. In the peeling device 22, the sheet W is peeled from the embossing roller 14 and wound on the peeling roller 20 while the sheet W is nipped with the embossing roller 14 and the peeling roller 20.

The peeled sheet W is conveyed to the sheet housing device 24, is wound up by the winding roll or the like of the sheet housing device 24, and is housed.

As already mentioned, a plurality of backup rollers are provided to oppose to each other in the region from the pressing spot (forming device 18) of the embossing roller 14 to the peeling spot (peeling device 22), and heat treatment can be performed while the sheet W is pressed with a plurality of backup rollers and the embossing roller 14.

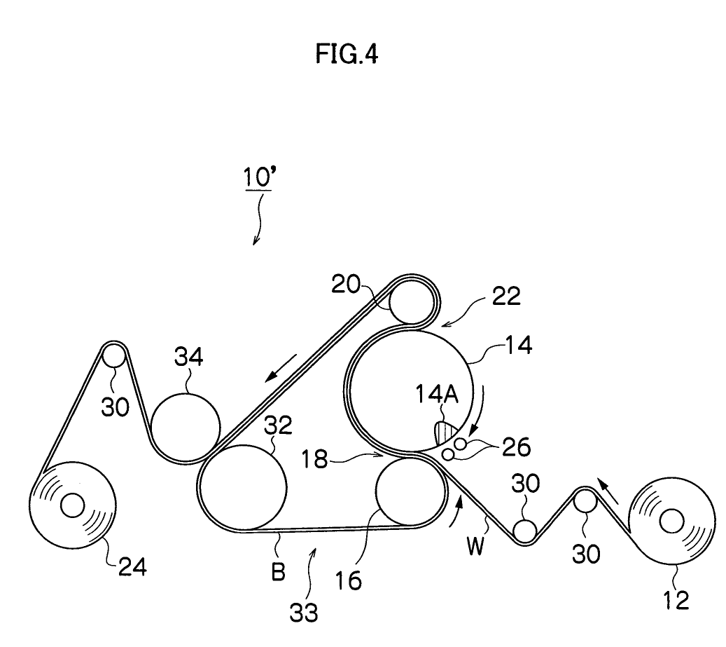

Next, another embodiment of the present invention will be explained. FIG. 4 is an explanatory view showing another construction of the production apparatus of an embossed sheet which is applied to the present invention. In this production apparatus 10′ of the embossed sheet, the components which are the same as or similar to the construction in FIG. 1 are given the identical numerals and the like, and the explanation of them will be omitted. In this production apparatus 10′ of the embossed sheet, the main part is the lateral inverse of the construction in FIG. 1, and the rotating directions of the embossing roller 14 and the nip roller 16 are the inverse of the construction in FIG. 1.

Unlike the production apparatus 10 of the embossed sheet of the construction in FIG. 1, in this production apparatus 10′ of the embossed sheet, the construction is adopted wherein a layered medium of the sheet W and a flexible band-shaped support medium B, which is placed on an undersurface of the sheet W, is made to run continuously, and roller work is performed with the embossing roller 14 and the nip roller 16. A support medium transporting device 33 for circularly transporting the endless belt B is adopted.

In this production apparatus 10′ of the embossed sheet, the endless belt B has its inner surface wound on the nip roller 16, the peeling roller 20 and a guide roller 32, and is conveyed to the counterclockwise direction shown by the arrow. The endless belt B is wound on the embossing roller 14 in the state in which the endless belt B is layered on the sheet W in the region from six o'clock position to twelve o'clock position. s In the peeling device 22, the endless belt B is wound on the peeling roller 20 in the state in which the endless belt B is layered on the sheet W, then is conveyed in the direction shown by the arrow, and is separated from the sheet W at the position where the guide roller 32 and a second peeling roller 34 oppose each other. Namely, the endless belt B is wound on the guide roller 32, circularly transported. The sheet W is wound on the second peeling roller 34, and is conveyed toward the sheet housing device 24.

The support medium B applied to the present invention is placed on an undersurface of the sheet W and is a flexible band-shaped sheet which supports the sheet W when continuously running as the layered medium. The support medium B is provided in order to prevent deformation of the sheet W even if the sheet W is in the easily deformed (hanging down) state due to high temperature of the preliminary heating when the sheet W is preliminarily heated. Accordingly, when the sheet W is preliminarily heated, the support medium B is required to have predetermined hardness, heat resistance and the like.

When the modulus of longitudinal elasticity (Young's modulus) as the hardness of the support medium B is too small, roller forming work of the sheet W becomes insufficient due to deformation of the support medium B, and when it is too large, the support medium B sensitively responds to entrapment of a foreign medium such as dust and easily causes a fault. Therefore, it is preferable to set the modulus of longitudinal elasticity at a proper value.

As such a support medium B, an aluminum sheet of a predetermined thickness, a metal sheet such as a stainless sheet, a resin sheet such as a PET film or the like having higher heat resistance than the sheet W, and the like can be used. When the sheets or the like are connected to form the endless belt B, it is preferable to prevent occurrence of a step at the joint portions.

Next, an operation of the production apparatus 10′ of the embossed sheet will be explained.

The sheet W is fed out at a constant speed from the sheet supplying device 12. The sheet W is layered on the endless belt B when the sheet W is wound on the nip roller 16. This layered medium is fed into the forming device 18 constituted of the embossing roller 14 and the nip roller 16. The upstream portion (approximately five o'clock position) of the pressing spot (six o'clock position) of the embossing roller 14 is heated locally by the local heating device 26 constituted of the dielectric heating coils provided close to the upstream portion. Thus, in the forming device 18, roller forming work is performed while the continuously running sheet W is pressed with the rotating embossing roller 14 and nip roller 16.

The layered medium passing through the forming device 18 is conveyed in the clockwise direction while being wound on the embossing roller 14, and fed to the peeling device 22. On this occasion, the surface temperature of the embossing roller 14 reduces due to the transfer forming temperature, and with this, the temperature of the sheet W also reduces. In the peeling device 22, while the layered medium is nipped with the embossing roller 14 and the peeling roller 20, the layered medium is peeled from the embossing roller 14, and is wound on the peeling roller 20.

The peeled layered medium is conveyed in the direction shown by the arrow, and at the position where the guide roller 32 and the second peeling roller 34 oppose to each other, the sheet W and the endless belt B are separated from each other. Namely, the endless belt B is wound on the guide roller 32, and circularly transported, and the sheet W is wound on the second peeling roller 34 and conveyed toward the sheet housing device 24.

The peeled sheet W is conveyed to the sheet housing device 24, is wound up by the winding roll or the like of the sheet housing device 24, and is housed.

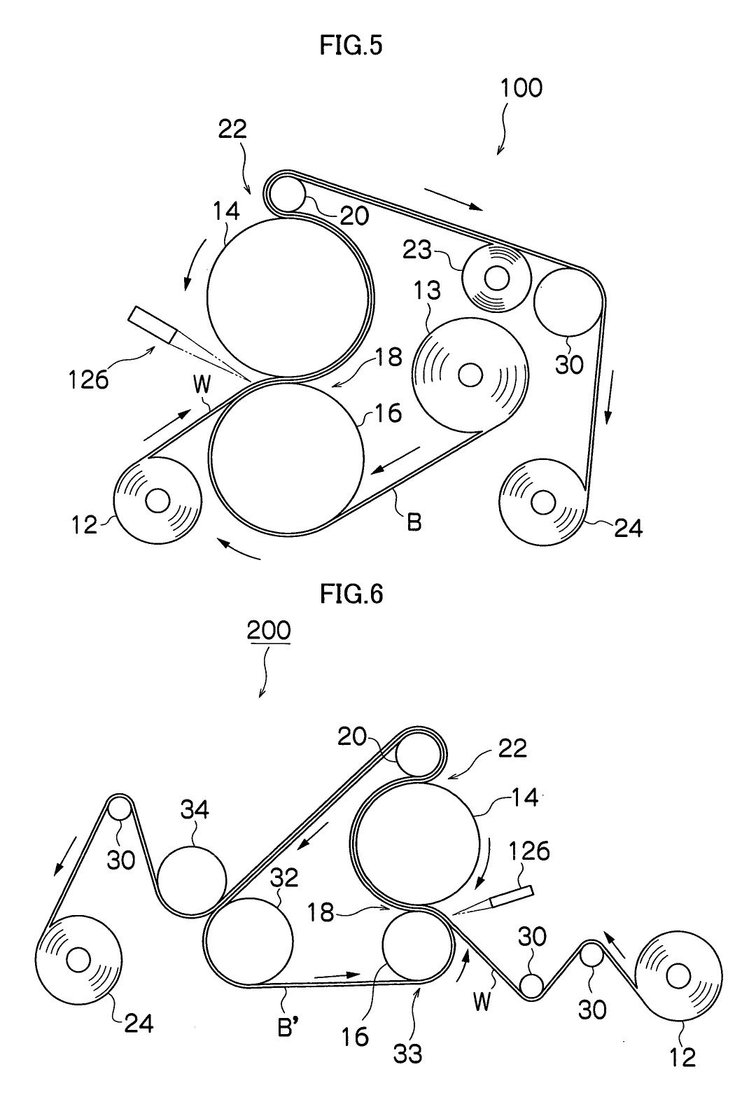

Next, based on the attached drawings, still another embodiment of the present invention will be explained. FIG. 5 is an explanatory view showing a construction of a production apparatus 100 of an embossed sheet which is applied to the present invention. The production apparatus 100 of the embossed sheet is constructed by the sheet supplying device 12, the support medium supplying device 13, the forming device 18 which is constituted of the embossing roller 14 (the indented roller) and the nip roller 16, the peeling device 22 constituted of the embossing roller 14 and the peeling roller 20, a support medium housing device 23, the sheet housing device 24, a preliminary heating device 126 which is a heating device constituted of a condensing heater or the like, and the like.

The constructions and functions of the sheet supplying device 12, the forming device 18 (the embossing roller 14 and the nip roller 16), the peeling device 22 (the embossing roller 14 and the peeling roller 20), the sheet housing device 24, the guide roller 30 and the like are substantially the same as those in the production apparatus 10 of the embossed sheet shown in FIG. 1 and the production apparatus 10′ of the embossed sheet shown in FIG. 4, and therefore the detailed explanation of them will be omitted.

The support medium supplying device 13 feeds out the band-shape flexible support medium B, and is constructed by a feeding roll or the like around which the support medium B is wound.

The sheet supplying device 12 is placed at the left of the nip roller 16, the support medium supplying device 13 is placed at the right of the nip roller 16. The support medium B, which is fed out by the support medium supplying device 13, is wound on the nip roller 16 at approximately half past four o'clock position of the nip roller 16, and is conveyed to the forming device 18 by the nip roller 16. The sheet W, which is fed out by the sheet supplying device 12, is wound upon the nip roller 16 via the support medium B at approximately half past ten o'clock position of the nip roller 16, and is conveyed to the forming device 18 by the nip roller 16 as the layered medium with the support medium B.

The support medium housing device 23 houses the support medium B after being peeled, and is constructed by the winding roll or the like which winds up the support medium B. The sheet housing device 24 which is provided at the downstream side of the support medium housing device 23 houses the sheet W after being peeled, and is constructed by the winding roll or the like, which winds up the sheet W.

The preliminary heating device 126 preliminarily heats the sheet W in the upstream portion (approximately eleven o'clock position) of the pressing spot (twelve o'clock position) of the nip roller 16, and it is constructed by the condenser heater provided at the left of the embossing roller 14.

In the support medium housing device 23, the mold releasing treatment can be applied onto the surface of the support medium B so that the support medium B is easily peeled from the sheet W when the support medium B is wound up. As such mold releasing treatment, various kinds of known methods, for example, coating treatment by a fluororesin can be adopted.

Further, such a mode can be adopted wherein roller forming work is performed with the heating temperature of the embossing roller 14 and the heating temperature of the nip roller 16 combined by setting the temperature of the entire embossing roller 14 to be lower than the temperature which enables roller forming, and the temperature of the nip roller 16 is set higher than the temperature which enables roller forming in order to keep the temperature of the embossing roller 14 in the peeling device 22 at a predetermined temperature or lower.

The preliminary heating device 126 constituted of the condensing heater heats the sheet W by light irradiation, and is preferable that the preliminary heating device 126 can uniformly heat the entire width of the sheet W. As the construction of such a condensing heater, for example, the condensing heater constituted of a bar-shaped infrared lamp placed in parallel with the embossing roller 14, and a reflector plate placed at a rear surface of the infrared lamp can be adopted.

As the preliminary heating temperature for the sheet W by the preliminary heating device 126, a proper value can be adopted in accordance with the set temperatures of the embossing roller 14 and the nip roller 16, the production speed (circumferential speed of the embossing roller 14), the medium of the sheet W, the indented pattern on the embossing sheet surface, and the like.

Though not shown, the construction can be adopted to provide with a cooling device by an air blow or the like, in order to cool the sheet W and the embossing roller 14 in the region from the pressing spot (six o'clock position) of the embossing roller 14 to the peeling spot (twelve o'clock position). By providing such a cooling device, the sheet W can be favorably peeled off in the peeling device 22.

Next, an operation of the production apparatus 100 of the embossed sheet will be explained.

The support medium B is fed out from the support medium supplying device 13 at a constant speed. The sheet W is also fed out from the sheet supplying device 12 at a constant speed. The layered medium with the sheet W layered on the top surface of the support medium B is fed into the forming device 18 constituted of the embossing roller 14 and the nip roller 16.

The sheet W in the upstream portion (approximately eleven o'clock position) of the pressing spot (twelve o'clock position) of the nip roller 16 is locally heated by the preliminary heating device 126 constituted of the condensing heater. In the forming device 18, roller forming work is performed while pressing the continuously running layered medium of the sheet W and the support medium B with the rotating embossing roller 14 and the nip roller 16. Since preliminary heating is performed by the condensing heater immediately before the roller forming work like this, the forming work can be performed with smaller loss.

In this case, if the heating temperature of the embossing roller 14 is too high, it becomes difficult to peel the sheet W from the embossing roller 14. On the other hand, when the heating temperature of the embossing roller 14 is made low and transfer is performed, even if the transfer precision is favorable immediately after the transfer, the residual stress occurs in the sheet-shaped medium, and thereby the problem of reducing the transfer precision by the subsequent heat treatment and the like is caused.

Accordingly, it is necessary to select a proper transfer forming temperature corresponding to the medium of the sheet W, the feeding speed and the like, and it is preferable to select a proper transfer forming temperature by obtaining the aforementioned stress relaxation curve as in FIG. 3 which is already described.

The layered medium which passes through the forming device 18 is conveyed to the counterclockwise direction while the layered medium is being wound on the embossing roller 14, and fed into the peeling device 22. In this case, the surface temperature of the sheet W becomes lower than the transfer forming temperature due to the action of the cooling device not shown, standing to cool and the like. In the peeling device 22, the layered medium is peeled from the embossing roller 14 and wound on the peeling roller 20 while the layered medium is being nipped with the embossing roller 14 and the peeling roller 20.

The peeled layered medium is conveyed to the support medium housing device 23, and the support medium B on the lower side of the layered medium is wound up by the winding roll of the support medium housing device 23, and is housed.

Then, the sheet W which is separated from the support medium B is conveyed to the sheet housing means 24, wound up by the winding roll of the sheet housing device 24, and is housed.

As already described, a plurality of backup rollers are provided to oppose to each other in the region from the pressing spot (forming device 18) of the embossing roller 14 to the peeling spot (pealing device 22), and heat treatment can be performed while the sheet W is being pressed with a plurality of backup rollers and the embossing roller 14.

Next, another embodiment of the present invention will be explained. FIG. 6 is an explanatory view showing another construction of the production apparatus of the embossed sheet which is applied to the present invention. In a production apparatus 200 of an embossed sheet, the same or similar components as or to those in the construction in FIG. 5 are given the identical numerals and the like, and the explanation of them will be omitted.

In the production apparatus 200 of the embossed sheet, a support medium transporting device 33 which circularly transports an endless belt B′ is adopted in place of the construction in which the support medium B is fed out of the support medium supplying device 13 and the support medium B is housed into the support medium housing device 23, in the production apparatus 100 of the embossed sheet of the construction in FIG. 5. As the endless belt B′, a metal sheet of a predetermined thickness such as an aluminum sheet and a stainless sheet, a resin sheet such as a PET film having more heat resistance than the sheet W, and the like as the support medium B can be used. When the endless belt B′ is formed by connecting sheets or the like, it is preferable to prevent a step from occurring to a joint portion.

In the production apparatus 200 of the embossed sheet, the endless belt B′ is conveyed to the counterclockwise direction shown by the arrow with an inner surface of the endless belt B′ wound on the nip roller 16, the peeling roller 20 and the guide roller 32. The endless belt B′ is wound on the embossing roller 14 in the state in which the endless belt B′ is layered on the sheet W in the region from six o'clock position to twelve o'clock position.

In the peeling device 22, the endless belt B′ is wound on the peeling roller 20 in the state in which the endless belt B′ is layered on the sheet W, conveyed to the direction shown by the arrow, and is separated from the sheet W at the position where the guide roller 32 and a second peeling roller 34 are opposed to each other. Namely, the endless belt B′ is wound on the guide roller 32 and circularly transported, and the sheet W is wound on the second peeling roller 34 and conveyed toward the sheet housing device 24.

The embodiments of the production method and the production apparatus of the pattern-indented sheet according to the present invention are explained thus far, but the present invention is not limited to the above-described embodiments, and various kinds of modes can be adopted.

For example, in the embodiments, the mode of using the embossing roller 14 as the indented roller is adopted, but the mode of using a belt-shaped medium such as an endless belt, on which surface the indented pattern (embossed shape) is formed can be adopted. This is because even such a belt-shaped medium operates as the cylindrical roller, and the same effect can be obtained.

The local heating device 26 constituted of the dielectric heating coils is adopted as the local heating device, but other than this, various kinds of heating devices such as an infrared heater, a halogen heater, a hot air generating device and a burner can be adopted.

In the embodiments, the sheet W is directly worked with the embossing roller 14, but the mode of providing the preliminary heating device at the upstream side of the embossing roller 14, and thereby performing preliminary heating of the sheet W can be adopted.

In the construction of the embodiment in FIG. 4, the support medium transporting device 33 for circularly transporting the endless belt B is adopted, but instead of this, the construction can be adopted wherein the support medium is fed out of the support medium supplying device or the like (a feeding roll around which the support medium is wound, or the like), and the support medium is housed in the support medium housing device or the like (a winding roll which winds up the support medium).

In the examples of the embodiments, the example in which roller forming work is performed while the sheet W is being pressed with the embossing roller 14 and the nip roller 16 which are rotating is explained, and this technique can be adopted in the extrusion method, the fused film forming method, an extrusion laminating method and the like.

### EXAMPLES

Next, a first example of the present invention will be explained in contrast to a comparative example. As the first example of the present invention, production of the embossed sheet was performed by using the production apparatus 10 of the embossed sheet of the construction shown in FIG. 1. The apparatus used in the comparative example was the same as the production apparatus 10 of the embossed sheet of the first example except for the point that the local heating device 26 was not provided.

The acrylic (polymetyl methacrylate) film of the thickness of 200 mm was used as the sheet W.

The roller made of S45C with the diameter of 200 mm was used as the embossing roller 14. The groove with the pitch in the roller axis direction of 50 mm was formed on substantially the entire surface of the roller. The sectional shape of the groove was a triangle shape with the vertex angle of 90 degrees, and the bottom portion of the groove was also in the triangle shape with 90 degrees without a flat portion. Namely, the groove width was 50 mm, and the groove depth was about 35 mm. This groove is endless without a joint in the circumferential direction of the roller, and therefore the lenticular lens with the triangular section can be formed on the sheet W by this embossing roller 14. Nickel plating was applied to the surface of the roller after the groove was worked.

The first example will be explained hereinafter.

The temperature of the entire embossing roller 14 was controlled so that the roller surface is at 100° C. The local heating device 26 was provided so that the spot to be heated 14A is located at the upstream by 30 mm from the forming device 18. The coil of the width of 20 mm was used as the local heating device 26, and was supplied with the electric current of the electric power of 10 kW. As a result, the spot to be heated 14A was heated at 220° C. under the condition of the circumferential speed of the embossing roller 14 of 5 m/min.

The roller with the diameter of 200 mm, on which surface the layer of silicon rubber of the rubber hardness of 90 was formed, was used as the nip roller 16. The nip pressure (effective nip pressure) at which the sheet W is pressed with the embossing roller 14 and the nip roller 16 was set at 1.47×10⁷ Pa (150 kg/cm²).

The embossed sheet was produced by changing the feeding speed of the sheet W (the rotational frequency of the embossing roller 14). When the embossed sheet was evaluated, and the feeding speed of the sheet W at which the transfer rate of the embossed shape was approximately 100% and peeling was able to be favorably performed, was looked up, the feeding speed was 5 m/min at the maximum.

The evaluation of the transfer rate of the embossed shape was performed by cutting the sheet W on which the indented pattern was formed, and measuring the sectional shapes of the indented pattern at a plurality of spots by the SEM (scanning electron microscope).

This embossed sheet was put into the oven, and heat treatment was performed for the embossed sheet at 100° C. for ten hours. When the transfer rate of the embossed shape was evaluated again, the transfer rate was 98%.

Next, the comparative example will be explained.

The temperature of the entire embossing roller 14 was controlled so that the roller surface is 140° C. The construction of the nip roller 16 was the same as the first example, and the nip pressure (effective nip pressure) was set at 1.47×10⁷ Pa (150 kglcmr), which was the same as in the first example.

The production of the embossed sheet was performed by changing the feeding speed of the sheet W (the rotational frequency of the embossing roller 14). When the embossed sheet was evaluated, and the feeding speed of the sheet W at which the transfer rate of the embossed shape was approximately 100% and peeling was able to be favorably performed, was checked, the feeding speed was 0.5 m/min at the maximum.

The evaluation of the transfer rate of the embossed shape was performed in the same manner as in the first example.

The embossed sheet was put into the oven, and heat treatment was applied to the embossed sheet at 100° C. for ten hours. Subsequently, the transfer rate of the embossed shape was evaluated again, and it was found out that the transfer rate was 50%. Namely, in the comparative example, the transfer rate was reduced via the heat treatment due to the residual stress.

From the above result, the effect of the present invention was confirmed.

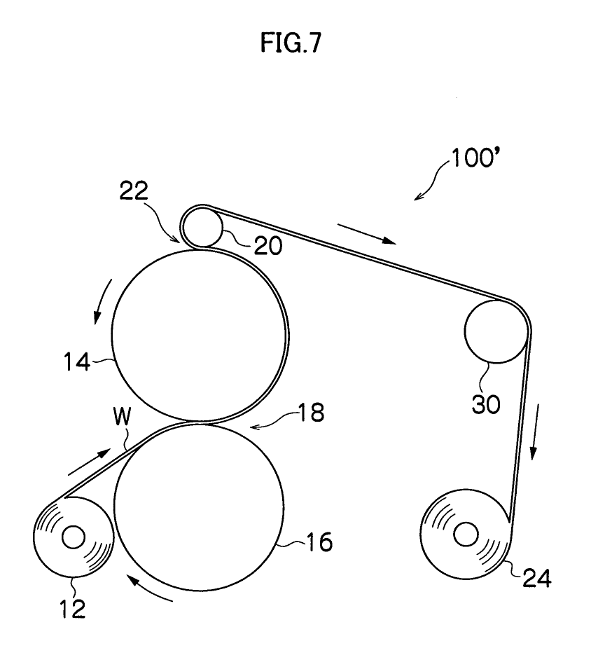

Next, a second example of the present invention will be explained in contrast to the comparative example. As the second example of the present invention, the embossed sheet was produced by using the production apparatus 100 of the embossed sheet of the construction shown in FIG. 5. As the comparative example, the embossed sheet was produced by using the production apparatus 100′ of the embossed sheet of the construction shown in FIG. 7.

The production apparatus 100′ of the embossed sheet, which was used in the comparative example, differed from the production apparatus 100 of the embossed sheet of the second example in the point that the support medium B was not used, and the preliminary heating device 126 was not provided. Namely, the production apparatus 100′ of the embossed sheet was the apparatus including the sheet supplying device 12 which fed out the sheet W, the forming device 18 which performed roller forming work while pressing the continuously running sheet W with the embossing roller 14 and nip roller 16 which were rotating, the peeling device 22 which peeled the sheet W from the embossing roller 14, and the sheet housing device 24 which housed the sheet W after being peeled. The same and similar members as and to those in the apparatus in FIG. 5 are given the identical reference numerals and characters, and the explanation of them will be omitted.

The aluminum sheet of the thickness of 200 mm was used as the support medium B. The surface of the support medium B, which is in contact with the sheet W, was previously coated with the mold release agent.

The acrylic (polymetyl methacrylate) film of the thickness of 200 mm was used as the sheet W.

The same embossing roller as in the first example was used as the embossing roller 14.

The second example will be explained hereinafter.

The temperature of the embossing roller 14 was controlled so that the roller surface is at 140° C. at six o'clock position.

The sheet W at the upstream portion by 10 mm of the forming device 18 was heated by the preliminary heating device 126. As a result, the sheet W was heated at 220° C. under the condition of the conveying speed of the sheet W (circumferential speed of the embossing roller 14) of 1.5 m/min.

The roller with the diameter of 200 mm, on which surface the layer of silicon rubber of the rubber hardness of 90 was formed, was used as the nip roller 16. The nip pressure (effective nip pressure) at which the sheet W was pressed with the embossing roller 14 and the nip roller 16 was set at 1.47×10⁷ Pa (150 kg/cm²).

The embossed sheet was produced by changing the feeding speed of the sheet W (the rotational frequency of the embossing roller 14). When the embossed sheet was evaluated, and the feeding speed of the sheet W at which the transfer rate of the embossed shape was approximately 100% and peeling was able to be favorably performed, was checked, the feeding speed was 1.5 m/min at the maximum.

The evaluation of the transfer rate of the embossed shape was performed by cutting the sheet W on which the indented pattern was formed, and measuring the sectional shapes of the indented pattern at a plurality of spots by the SEM (scanning electron microscope).

This embossed sheet was put into the oven, and heat treatment was performed for the embossed sheet at 100° C. for ten hours. When the transfer rate of the embossed shape was evaluated again, the transfer rate was 80%.

Next, the comparative example will be explained.

The temperature of the entire embossing roller 14 was controlled so that the roller surface is at 140° C. The construction of the nip roller 16 is the same as the second embodiment, and the nip pressure (effective nip pressure) was set at 1.47×10⁷ Pa (150 kg/cm²), which was the same as in the second example.

The production of the embossed sheet was performed by changing the feeding speed of the sheet W (the rotational frequency of the embossing roller 14). When the embossed sheet was evaluated, and the feeding speed of the sheet W at which the transfer rate of the embossed shape was approximately 100% and peeling was able to be favorably performed, was checked, the feeding speed was 0.5 m/min at the maximum.

The evaluation of the transfer rate of the embossed shape was performed in the same manner as in the second example.

The embossed sheet was put into the oven, and heat treatment was applied to the embossed sheet at 100° C. for ten hours. Subsequently, the transfer rate of the embossed shape was evaluated again, and the transfer rate was 50%. Namely, in the comparative example, the transfer rate was reduced via the heat treatment due to the residual stress.

From the above result, the effect of the present invention was confirmed.

1. A production method of a pattern-indented sheet comprising the steps of:
pressing a continuously running sheet-shaped medium with a indented roller and a nip roller which are rotating so as to transfer and form indentation of the indented roller surface onto a surface of the sheet-shaped medium; and
locally heating an upstream portion of a pressing spot of the indented roller.

2. The production method of the pattern-indented sheet according to claim 1, wherein the local heating is performed by a dielectric heating method.

3. The production method of the pattern-indented sheet according to claim 1, wherein a height of the indentation of the sheet-shaped medium surface by the transferring and forming is 90% or more of a height of the indentation of the indented roller surface.

4. A production method of a pattern-indented sheet comprising the steps of:
continuously running a layered medium of a sheet-shaped medium and a band-shaped flexible support medium placed on an undersurface of the sheet-shaped medium;
pressing the layered medium with the indented roller and a nip roller which are rotating so as to transfer and form indentation of an indented roller surface onto a surface of the sheet-shaped medium; and
locally heating an upstream portion of a pressing spot of the indented roller.

5. The production method of a pattern-indented sheet according to claim 4, wherein the local heating is performed by a dielectric heating method.

6. The production method of the pattern-indented sheet according to claim 4, wherein a height of the indentation of the sheet-shaped medium surface by the transferring and forming is 90% or more of a height of the indentation of the indented roller surface.

7. A production apparatus of a pattern-indented sheet comprising:
a sheet-shaped medium supplying device which feeds out a sheet-shaped medium;
a forming device which presses the sheet-shaped medium with an indented roller and a nip roller which are rotating so as to work the continuously running sheet-shaped medium by roller forming; and
a local heating device which locally heats an upstream portion of a pressing spot of the indented roller.

8. The production apparatus of a pattern-indented sheet according to claim 7, further comprising:
a peeling device which peels the sheet-shaped medium from the indented roller; and
a sheet-shaped medium housing device which houses the sheet-shaped medium after the peeling.

9. The production apparatus of a pattern-indented sheet according to claim 7, wherein the local heating device is a dielectric heating device provided in the vicinity of the indented roller.

10. A production apparatus of a pattern-indented sheet comprising:
a sheet-shaped medium supplying device which feeds out a sheet-shaped medium, a support medium transporting device which circularly transports a band-shaped flexible support medium which is an endless belt;
a forming device which continuously runs a layered medium of the sheet-shaped medium and the support medium placed on an undersurface of the sheet-shaped medium, and presses the layered medium with an indented roller and a nip roller which are rotating so as to work the sheet-shaped medium by roller forming;
a peeling device which peels the layered medium from the indented roller; and
a local heating device which locally heats an upstream portion of a pressing spot of the indented roller.

11. The production apparatus of a pattern-indented sheet according to claim 10, wherein the local heating device is a dielectric heating device provided in the vicinity of the indented roller.

12. A production method of a pattern-indented sheet comprising the steps of:
continuously running a layered medium of a sheet-shaped medium and a band-shaped flexible support medium placed on an undersurface of the sheet-shaped medium;
pressing the layered medium with the indented roller and a nip roller which are rotating so as to transfer and form indentation of an indented roller surface onto a surface of the sheet-shaped medium; and
heating the sheet-shaped medium in an upstream portion of a pressing spot of the indented roller.

13. The production method of a pattern-indented sheet according to claim 12, wherein the heating is performed by a condensing heater.

14. The production method of a pattern-indented sheet according to claim 12, wherein a height of the indentation of the sheet-shaped medium surface by the transferring and forming is 90% or more of a height of the indentation of the indented roller surface.

15. A production apparatus of a pattern-indented sheet, comprising:
a sheet-shaped medium supplying device which feeds out a sheet-shaped medium;
a support medium supplying device which feeds out a band-shaped flexible support medium;
a forming device which continuously runs a layered medium of the sheet-shaped medium and the support medium placed on an undersurface of the sheet-shaped medium, and presses the layered medium with an indented roller and a nip roller which are rotating so as to work the sheet-shaped medium by roller forming; and
a heating device which heats the sheet-shaped medium in an upstream portion of a pressing spot of the forming device.

16. The production apparatus of a pattern-indented sheet according to claim 15, further comprising:
a peeling device which peels the layered medium from the indented roller;
a support medium housing device which houses the support medium after the peeling; and
a sheet-shaped medium housing device which houses the sheet-shaped medium after the peeling.

17. The production apparatus of a pattern-indented sheet according to claim 15, wherein the heating device is a condensing heater provided in the vicinity of the forming device.

18. A production apparatus of a pattern-indented sheet, comprising:
a sheet-shaped medium supplying device which feeds out a sheet-shaped medium;
a support medium transporting device which circularly transporting a band-shaped flexible support medium which is an endless belt;
a forming device which continuously runs a layered medium of the sheet-shaped medium and the support medium placed on an undersurface of the sheet-shaped medium, and presses the layered medium with an indented roller and a nip roller which are rotating so as to work the sheet-shaped medium by roller forming;
a peeling device which peels the layered medium from the indented roller; and
a heating device which heats the sheet-shaped medium in an upstream portion of a pressing spot of the forming device.

19. The production apparatus of a pattern-indented sheet according to claim 18, wherein the heating device is a condensing heater provided in the vicinity of the forming device.
